(19) United States
(12) Patent Application Publication
(10) Pub. No.: US 2009/0307744 A1
(43) Pub. Date: Dec. 10, 2009

(54) AUTOMATING TRUST ESTABLISHMENT AND TRUST MANAGEMENT FOR IDENTITY FEDERATION

(75) Inventors: Arun K. Nanda, Sammamish, WA (US); Matthew F. Steele, Bellevue, WA (US); Danver W. Hartop, Sammamish, WA (US); Sriram Vasudevan, Redmond, WA (US); Edward P. Johns, Tacoma, WA (US); Colin H. Brace, Seattle, WA (US); Vijay K. Gajjala, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/135,570

(22) Filed: Jun. 9, 2008

(51) Int. Cl. G06F 17/00

(52) U.S. Cl. 726/1

(57) ABSTRACT

A federated identity verification system includes an identity provider that provides security tokens ultimately to one or more relying parties for access by the client to services at a relying party. Specifically, the relying party can validate the security token from an identity provider (whether directly or via a client) when verifying that the received security token conforms to security configuration data previously exchanged with the identity provider. To establish the trust relationship, the identity provider and one or more relying parties exchange security configuration information through an agreed-to communication channel. The security configuration information indicates the settings that the other party needs to use for establishing, maintaining, and/or monitoring the trust relationship. The communication channel allows both parties to flexibly and continually synchronize changes to security configurations, and thus maintain, change, or end the trust relationship automatically, as desired.

### CROSS-REFERENCE TO RELATED APPLICATIONS

N/A

### BACKGROUND

1. Background and Relevant Art

Conventional computer systems are now commonly used for a wide range of objectives, whether for productivity, entertainment, or the like. One reason for this is that computer systems tend to add efficiency with task automation, as well as making certain types of transactions more efficient. For example, some types of transactions in the past might have taken users hours or days to complete. In particular, if a user were to make a bank deposit, bank transfer, or even purchase items in a store, the user might have needed to physically travel to the bank or store location in order to verify the user's identity and present instructions for the transaction. Upon verifying the user's identity, the bank or store might then initiate and confirm the requested transaction. In this scenario, the bank or store could be considered a “relying party,” which relies on the in-person identity provided by the user, who is an “identity provider.”

More recently, however, automated (or computerized) mechanisms have reduced these types of transactions to seconds or minutes. In particular, transactions such as the above have become more and more efficient and complex due to the presence of automated terminals, which allow the user to execute transactions from remote locations. Rather than relying on in-person identity verification, however, automated terminals allow the user to satisfy a number of challenge and response scenarios before providing access to services. For example, the user might need to present an account card and personal identification number, which were previously received from the relying party when establishing a trust relationship between the user and relying party.

As with automated terminals, more recent internet-based relying parties also request that the end-user establish a trust relationship of some sort, often through requiring the user to provide some verifiable personal information (e.g., name, address, birthday, etc.) The relying party might also require the user to present other third-party verification information, such as credit card information, driver's license information, or social security card information. In these types of cases, the relying party relies not only on the user's self-verification information, but also on verification by other parties (e.g., credit card company, or governmental entity) with which the relying party has already established a trust relationship. The relying party can thus require the user to present some or all of the personal and third-party information previously exchanged when the user subsequently accesses the relying party's services.

Due to the efficiency gains usually provided through online transactions, a growing number of entities are providing services this way, and users are increasingly demanding use of the same. This growth in online transactions, however, has generated another set of problems. That is, users often now have a large and growing number of different online accounts that they need to track and maintain. Particularly in the case where the user provides different verification information to each different relying party, the user may need to remember or have access to a growing number of different usernames, passwords, and potentially other verification information.

Some conventional mechanisms attempt to mitigate some of these concerns by implementing “federated” identity verification systems. In federated systems, a separate identity provider maintains data that can be used to generate one or more security tokens) for many of a user's different accounts at various relying parties. In general, a “security token” is the means by which an identity provider asserts a user's identity to a relying party. So that the security tokens are portable across many different relying parties, this type of identity provider will need to establish a trust relationship with each of the different relying parties for which the user would like access.

Thus, when the user desires access to a particular service at a relying party, the user can contact the identity provider, verify himself to the identity provider, and obtain a token from the identity provider. The user can then present the token from the identity provider, which contains some claims about the user and/or user's client system (and some information about the identity provider), to the relying party. Since the relying party trusts the identity provider and the user, the relying party can use the provided information to validate the token, and, if validated, provide the user with access to variously requested services or transactions.

While a federated identification system might mitigate some concerns for the user, setting up the initial trust relationship between the identity provider and each relying party, and vice versa, can be somewhat involved. For established token granting services (e.g., those using the Kerberos protocol), for example, relying parties and identity providers using the same protocol may already be configured with the appropriate trust settings and configurations, and so little additional effort may be required to establish the trust relationship. Since there is generally no centralized control over identity providers and relying parties, however, there is often a disconnect between any given identity provider and relying party, since both may have fairly different security requirements and supported protocols. As a result, setting up a trust relationship generally involves a number of manual efforts between one or more administrators at the identity provider and at the one or more relying parties, and such efforts can be complex and cumbersome. Furthermore, in either the established or new identity provider case, processing changes to the security configurations can also be complex and cumbersome, particularly when considering relationships with hundreds or thousands of other parties.

For example, establishing and maintaining changes to trust relationships typically involves manual efforts involved with agreeing to certain terms and conditions about token types, certificates, signing mechanisms, and so forth, as well as an exchange of some security information. In some cases, for example, administrators at the identity provider and relying party may exchange keys and security data electronically via email, while, in other cases, the administrators of either party may need to physically transport or send some physical storage media to the other party. Once exchanged, the parties can then install the necessary configurations and coordinate the issuance and validation of tokens.

Accordingly, one will appreciate that the aforementioned trust establishment processes can be error prone and complex. Furthermore, such conventional trust establishment processes tend to make the trust relationship relatively inflexible over time, and can restrict either of the identity provider's or relying party's ability to change some of its trust configurations or protocols later on. Furthermore, such processes can limit the introduction of new identity providers or new relying parties, particularly parties that may desire to establish trust relationships (and thus send or verify client tokens) with hundreds or thousands of other identity providers or relying parties at a time.

Thus, there are a number of difficulties with federated systems that need to be addressed, particularly as entities increasingly move toward providing online, internet-based services, and as users continue to demand such services.

### BRIEF SUMMARY

Implementations of the present invention overcome one or more problems in the art with systems, methods, and computer program products configured to automate trust establishment processes between identity providers and relying parties in a federated identity system. In one implementation, for example, a party to a trust relationship, such as an identity provider, publishes configuration information for establishing, monitoring, and maintaining a trust relationship with another party, such as a relying party. The other party, e.g., the relying party, can also publish its own configuration information. The parties to the trust relationship can then continually and automatically obtain each other's published information through an agreed-to channel that is independent of a channel used by the client. Both parties can thus flexibly and continually maintain, end, or renew a trust relationship with each other, and/or virtually any number of other parties at any time.

For example, a method from the perspective of an identity provider of securely and automatically establishing, monitoring, and maintaining a trust relationship can involve publishing a document pertaining to a trust relationship. The published document defines security configuration data for the identity provider. The method can also involve receiving one or more documents through a first communication channel from a relying party pertaining to the trust relationship. In this case, the received document defines security configuration data for the relying party.

In addition, the method can involve processing the document received from the relying party to determine whether to establish the trust relationship. Furthermore, the method can involve, upon establishing the trust relationship, sending one or more security tokens to be validated by the relying party. In this case, the one or more security tokens conform to security configurations received from the relying party via the first communication channel.

In addition to the foregoing, a method from the perspective of a relying party of securely and automatically establishing, monitoring, and maintaining a trust relationship can involve publishing an electronic document pertaining to a trust relationship on a first communication channel. Here, the published electronic document defines security configuration data for the relying party. The method can also involve receiving one or more electronic documents through the first communication channel from an identity provider pertaining to the trust relationship. In this case, the received one or more electronic documents define security configuration data for the identity provider.

In addition, the method can involve processing a most recent copy of the received document from the identity provider to determine whether to maintain the trust relationship. Furthermore, the method can involve validating one or more security tokens received from a client through a second communication channel. In this case, the received one or more security tokens conform to the most recent security configuration data received from the identity provider via the first communication channel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an overview schematic diagram in accordance with an implementation of the present invention in which an identity provider and a relying party exchange security configuration information pursuant to establishing a trust relationship;

FIG. 1B illustrates the schematic shown in FIG. 1A in which a client obtains a token from the identity provider that conforms with the agreed-to trust relationship set up between the identity provider and relying party, and provides the token to the relying party;

FIG. 1C illustrates the schematic shown in FIGS. 1A and 1B in which the identity provider and relying party automatically update security configurations;

FIG. 2 illustrates a flow chart of one or more acts in a method from the perspective of an identity provider for sending one or more tokens in accordance with a relationship established with a relying party; and

FIG. 3 illustrates a flow chart of one or more acts in a method from the perspective of a relying party for validating client tokens that conform to the security configurations and trust relationship established with an identity provider.

### DETAILED DESCRIPTION

Implementations of the present invention extend to systems, methods, and computer program products configured to automate trust establishment processes between identity providers and relying parties in a federated identity system. In one implementation, for example, a party to a trust relationship, such as an identity provider, publishes configuration information for establishing, monitoring, and maintaining a trust relationship with another party, such as a relying party. The other party, e.g., the relying party, can also publish its own configuration information. The parties to the trust relationship can then continually and automatically obtain each other's published information through an agreed-to channel that is independent of a channel used by the client. Both parties can thus flexibly and continually maintain, end, or renew a trust relationship with each other, and/or virtually any number of other parties at any time.

As will be understood more fully herein, implementations of the invention can make use of a metadata document, which is published and/or retrieved by various parties for communicating trust information. In one implementation with particular respect to a MICROSOFT operating environment, such a document can be created and provided through constructs in the WS-FEDERATION industry standard. Of course, one will appreciate that implementations of the present invention can be practiced in a wide range of operating environments. Accordingly, any reference herein to any operating system-specific component, module, or code is merely by way of descriptive convenience.

In any event, the metadata documents that both parties publish can be configured to inform and update local policy representing the trust relationship. Parties to the trust relationship, therefore, can be configured with one or more protocols for notifying or for polling each other for updates to their trust information, in order to keep the trust information synchronized. In one implementation of the present invention, a service (e.g., an NT service) at any party in an established trust relationship can be configured to automate the processes for a variety of common case scenarios of trust data changed (e.g., the identity provider's token signing certificate, or the relying party's token encryption certificate has been changed).

Accordingly, and as will be understood more fully herein, implementations of the present invention generally relate to utilizing metadata document sections for indicating trust information (e.g., certificates, claim types supported and required, and connectivity information). Such trust information can relate to establishing trust between a any particular relying party and identity provider, and vice versa. Implementations of the present invention also relate to one or more protocols for publishing and retrieving trust information as part of trust establishment. Along these lines, implementations of the present invention further relate to publishing and retrieving such information pursuant to continued trust management through changes to trust information. Such changes can include, but are not limited to, issuer (identity provider) and acceptor (relying party) key roll over, claim type changes, and end-point configuration changes.

Still further, implementations of the present invention generally relate to trust management processes that involve administrator-controlled processes. In one implementation, administrator-controlled processes include notifications of pending trust establishment requests that are delivered through an email, through an approval workflow process, etc. In addition, implementations of the present invention generally relate to trust management processes that involve automated processes (i.e., non administrator-controlled). Such automated processes can include automatic key roll over, and automatic endpoint configuration changes.

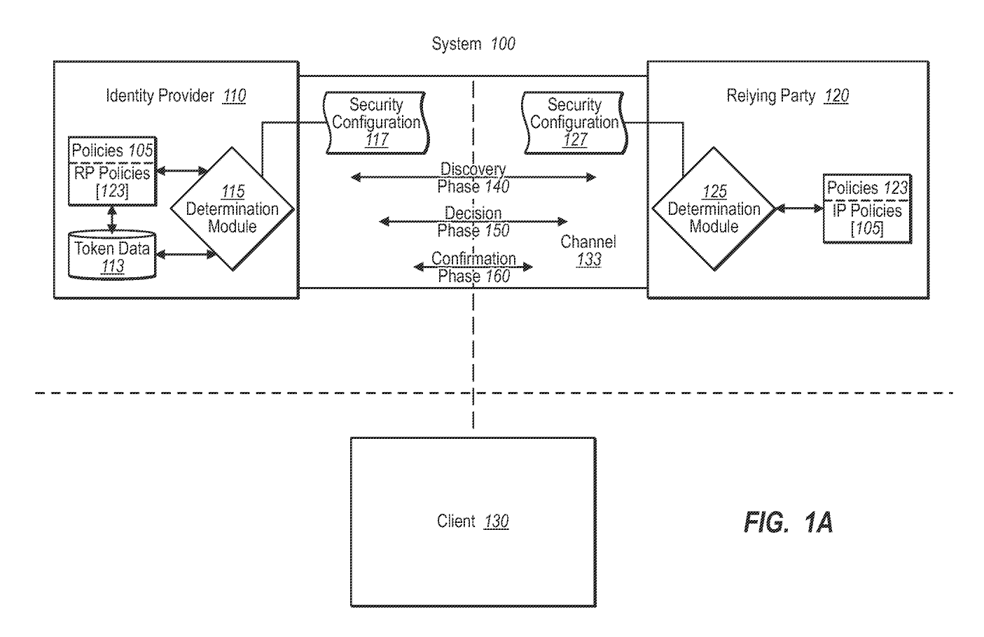

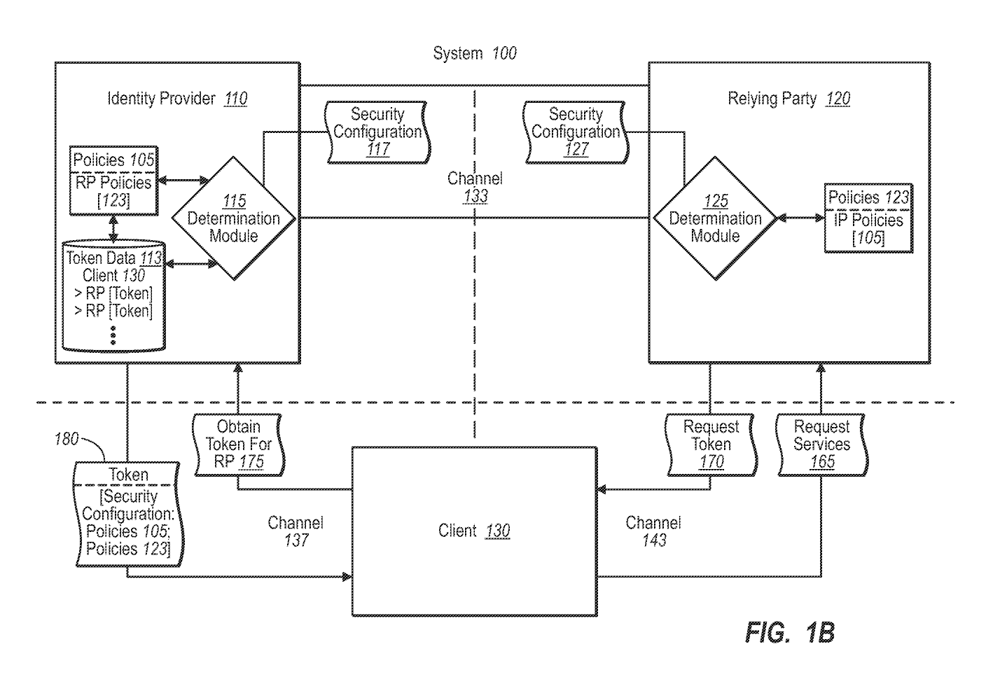

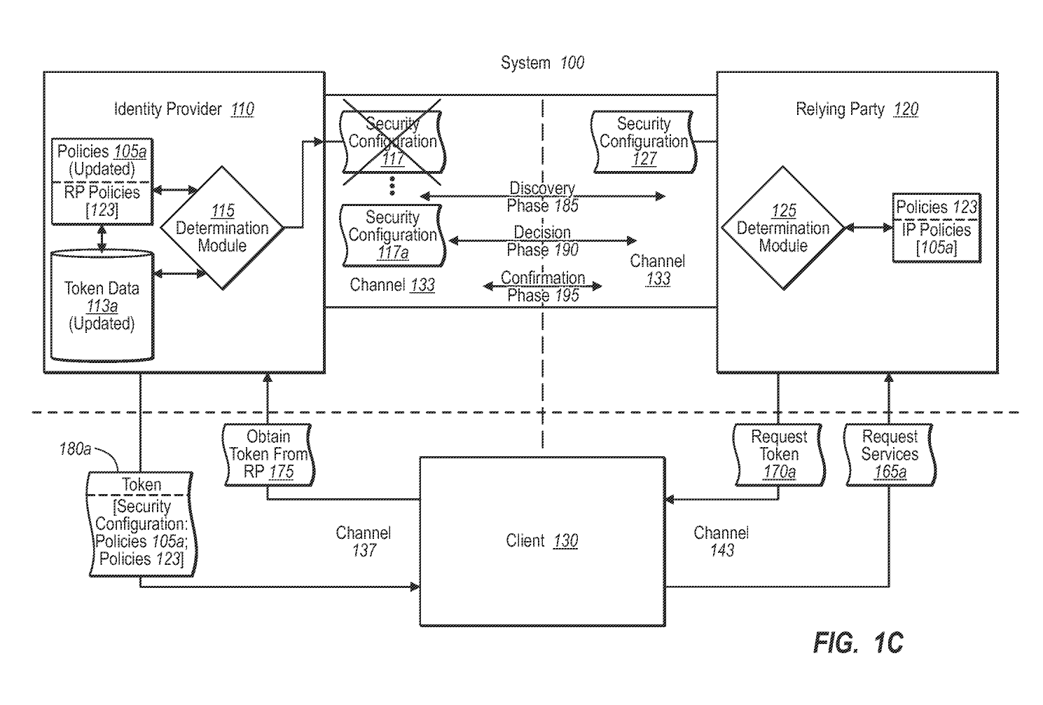

Referring now to the figures, FIG. 1A illustrates an overview schematic diagram of a federated system 100 for providing and validating user tokens for access to services. In particular, FIG. 1A shows that federated system 100 comprises one or more relying parties 120, which provide services to one or more clients 130. The one or more relying parties 120, in turn, require one or more security tokens (also referred to herein simply as “tokens”) from the one or more clients 130 (and/or directly from another provider) so that the client can access the respective relying party's 120 services. For example, the relying party 120 is a bank or an online store, and requires one or more tokens from a client (or an identity provider that has a relationship with the client), so that the client can access the bank or online store if the relying party can validate the security token (or claims of the security token).

For example, FIG. 1A shows that identity provider 160 comprises one or more token data repositories 113, which typically comprise data for a particular user, and is used to generate one or more security tokens to be validated at one or more relying parties 120. In particular, the one or more token data repositories 113 comprise various sets of data to be used in generating one or more security tokens, for each given user at one or more client systems 130, and/or the client system 130 alone. In additional or alternative implementations, however, the identity provider 110 may also or alternative store the actual tokens themselves in repository 113. The various security tokens that are generated by the identity provider 110, in turn, provide one or more claims about the given user, and are used to assert the identity of a particular user.

In any event, and as previously discussed, however, the security tokens that are generated from this data (in repository 113) are only valid for use (e.g., by the client) when the one or more relying parties 120 can only verify or validate the given security tokens (or corresponding data contained therein). The relying party 120, in turn, can only validate the tokens from the identity provider 110 when the relying party 120 has a valid trust relationship with the identity provider 110. Accordingly, FIG. 1A illustrates an implementation in which the identity provider 110 and relying party 120 establish a trust relationship. For example, FIG. 1A shows identity provider 110 comprises a set of security policies 105, and similarly that relying party 120 also comprises set of its own security policies 123. In general, the various sets of security policies 105, 123 at the identity provider 110 and relying party 120 comprise any number or range of security configurations and preferences that each party requires for establishing the trust relationship.

For example, such policy information can comprise preferences for network communication protocols for transferring security configuration documents, types of digital signatures that will be used to sign such documents. In addition, the policies 105, 123 can also include preferences regarding endpoints and communication channels, communication ports, and so forth, as well as preferences for private or public keys used to encrypt communications (e.g., token transmissions). Furthermore, such as in the identity provider 110 case, policies (e.g., 105) can include various information about the security tokens that can be issued for client 130, including the security token types that can be issued, the types of claims about the user that the security tokens can contain, the cryptographic keys that will be used to sign the tokens, and the like. The security policies 105, 123 can also include various administrator-directed preferences, including the frequency with which a party plans to roll over or change its security configuration.

The identity provider 110 and relying party 120, in turn, can publish one or more aspects of the security policies 105, 123 in a discoverable form through corresponding security configuration documents. For example, FIG. 1A shows that identity provider 110 publishes one or more security configuration documents 117, while relying party 120 publishes one or more security configuration documents 127. In general, the published documents 117 and 127 comprise a discoverable subset of the security information found in the policies 105 or 123, and specifically comprise information that another party will need to use in order to maintain a trust relationship with the publishing party.

In general, the published documents 117 and 127 can include certain security information, similar to policies 105, 123, albeit in metadata document form (e.g., WS-FEDERATION standard constructs). As with security policies 105, 123, the published metadata in documents 117 and 127 can comprise security configuration about protocol endpoints, various identifiers for the publishing party, what another party should expect to find out about a user (e.g., specific surname formats, birthday or personal identification number formats, etc.) The security configuration metadata in documents 117 and 127 can also include information about digital certificates that the other party should expect to find in a token signature, as well as key material, such as public keys, and whether the keys to be used are symmetric or asymmetric, etc.

Thus, when either the identity provider 110 or relying party 120 are ready to establish a trust relationship with the other, either such interested party can then begin the trust establishment protocol. For example, FIG. 1A shows that identity provider 110 and relying party 120 establish a trust establishment through a communication protocol that involves a plurality of steps, which include a discovery phase 140, a decision phase 150, and a confirmation phase 160, all of which occur through a unique communication channel (e.g., illustrated as 133). Thus, at the outset, this initiation of the trust relationship involves a discovery phase 140, in which the interested party discovery's another party's security configuration metadata, and/or publishes security configuration metadata for discovery by the other party.

There are a number of ways in which a party can initiate the discovery phase 140. In at least one implementation, for example, the relying party 120 or identity provider 160 sends one or more messages (not shown) to the other party, asking if the party is open for creating a trust relationship. If the contacted party (e.g., the identity provider 110, if the relying party 120 initiated contact) is available for a trust relationship, the contacted party can reply with an indication of one or more endpoints or communication protocols that can be used to discover security configuration information (e.g., document 117). In additional or alternative implementations, the party that is interested in initiating the trust relationship may already be aware of the communication channel 133 and relevant endpoints, and thus either directly sends (pushes) its own security configuration document (117 or 127) to the other party, or directly requests (and pulls) a published security configuration document (117 or 127) from the other party.

For example, if identity provider 110 had interest in setting up a trust relationship with relying party 120, identity provider might initially send one or more messages to identify an appropriate communication channel 133 for identifying security configuration document 127. In one implementation, this initial request could further comprise a copy of security configuration document 117, which is published by identity provider 160. If relying party 120 is open to the trust relationship, relying party 120 might respond positively by providing the endpoint for security configuration document 127, or alternatively responding with a copy of security configuration document 127.

Of course, one will appreciate that the interest in setting up the trust relationship in the first instance can also occur in a number of different ways. In one implementation, for example, identity provider 110 only becomes aware of relying party 120 in response to a message from client 130. For example, a user at client 130 desires to use one or more services of relying party 120, and has never established a relationship with relying party 120. When the user contacts relying party 120 through client 130, relying party 120 could instruct client 130 to provide a token or otherwise set up a token, at which point client 130 might send a message to identity provider 110. If identity provider 110 has never worked with relying party 120, this scenario might trigger the interest by identity provider 110 to initiate discover phase 140.

Similarly, when client 130 contacts relying party 120 for the first time, client 130 might respond to a request for a token with an indication of the identity provider 110 that client 130 uses for such requests. Thus, relying party 120 (rather than identity provider 110, as discussed above) might alternately decide to initiate the discovery phase 140 with identity provider 110. In such a case, relying party 120 could, for example, initiate and complete establishment of the trust relationship with identity provider 110 without any further involvement from client 130. Thus, the federation providers (e.g., identity provider 110 and relying party 120) could initiate interest to establish the trust relationship on their own, or as a reaction to client 130 requests.

Regardless of how either party initiates and completes (e.g., both exchanging and receiving documents 117, 127) the discovery phase 140, both parties can subsequently enter to a decision phase 150 in the trust establishment protocol. In general, decision phase 150 involves both the identity provider 110 and relying party 120 matching or correlating the received security configuration documents 117 or 127 with their respective policies 105 or 123. For example, FIG. 1A shows that identity provider 110 comprises determination module 115, which compares relying party policies 123 to identity provider policies 105. Similarly, FIG. 1A shows that relying party 120 comprises determination module 125, which compares identity provider policies 105 with relying party policies 123.

In at least one implementation, the determination phase can involve a number of different automated and/or non-automated (e.g., administrator directed) workflows at the identity provider 110 or relying party 120. In both cases, the determination modules 125 compare the respective policies and security configurations to identify if they can use the same protocols, if they use the same digital signatures, and so forth, and/or can operate with the other party based on the other party's requirements or expectations. The identity provider 110 and/or relying party 120 can then make a decision one way or another about the received security configuration information (in document 117 or 127). As discussed herein, the decision process may involve one or more workflows at either or both of the identity provider 110 and/or relying party 120.

Both parties can then enter into a confirmation phase 160 in which the parties 110 and 120 confirm or deny the ability to set up the trust relationship. For example, if identity provider 110 cannot conform to the demands of security configurations 127, identity provider 110 can send one or more acknowledgements to relying party 120 to indicate that there is an error, or that no trust relationship will be established. Identity provider 110 can further send a message to client 130 confirming the same, or otherwise request guidance from client 130 about how to proceed. Similarly, if relying party 120 cannot conform to the security configurations 117 of identity provider 110, relying party 120 can send one or more acknowledgements to identity provider 110 confirming that no trust relationship can be established. In such a case, relying party 120 might also send one or more messages to client 130 indicating the same.

In most cases, however, identity provider 110 and relying party 120 will be able to establish the trust relationship by making only minor accommodations. For example, relying party may require tokens and communication protocols that identity provider 110 is already using, or is readily capable of using for client 130. Similarly, relying party 120 may determine that it is able to accept tokens and communications from client 130 and/or from identity provider 110 in the format and protocol required by identity provider 110. In such a case, therefore, confirmation phase 160 involves the identity provider 110 and relying party 120 sending (and receiving) one or more acknowledgement messages to or from the other party. The acknowledgement messages in confirmation phase 160 can include not only a positive affirmation that the trust relationship can be established, but also any necessary configuration information that confirms specific protocols and formats that will be used in the relationship. As previously mentioned, the confirmation phase 160, as with the discovery phase 140 and determination phase 150, comprises communications in a communication channel 133 that is different from the communication channels used with client 130.

FIG. 1B illustrates an implementation of what can occur once the parties 110 and 120 have confirmed establishment of the trust relationship. Notably, FIG. 1B is particularly directed to the case in which the identity provider 110 and relying party 120 exchange and validate tokens through client 130. One will, of course, appreciate that identity provider 110 and relying party 120 can communicate and validate tokens directly to or from the other party, without explicit client involvement. Thus, FIG. 1B illustrates one exemplary implementation of the present invention for purposes of descriptive convenience.

In the illustrated case, FIG. 1B shows that client 130 sends one or more requests 165 for services to relying party 120 through communication channel 143. In response, FIG. 1B shows that relying party 120 then sends one or more responses 170 back through the communication channel 143, which request a token (e.g., from the client 130) for access to the requested services. Additionally, FIG. 1B shows that client 130 then processes request 170, and passes message 175 through communication channel 137 to identity provider 110. Identity provider 110 then processes message 175 through determination module 115.

For example, and as previously described, determination module 115 reviews its set of tokens or source data for tokens in repository 113, and generates a security token that corresponds to the relying party 120 and for client 130. Specifically, determination module 115 generates a token that conforms to the security configurations agreed to with relying party 120, and that is associated with client 130 (or user at client 130). As shown in FIG. 1B, identity provider 110 then sends one or more messages 180 to client 130 that relay the identified and generated security token to client 130. For example, FIG. 1B shows that identity provider 110 sends to client 130 one or more messages 180, which comprise one or more tokens that are not only specific to client 130, but also conform to policies 105 and 123.

In this case, client 130 can then send the token received via the one or more messages 180 to relying party 120. Relying party 120 can then process the token (of one or more messages 180) through determination module 125. If determination module 125 can determine that the token received from client 130 conforms to the expectations of the trust relationship, that is, the specific security policies and configurations previously exchanged with identity provider 110, determination module 125 will validate this token. Relying party 120 can then send one or more confirmation messages to client 130 that allow client 130 to engage the requested services (e.g., from message 165) at relying party 120.

Of course, one will appreciate that there may be instances when an identity provider 110 and relying party 120 will want to change their existing security policies 105, 123. In some cases, this could mean that a token provided by client 130 (and/or provided directly by identity provider 110) no longer conforms to a particular policy at one or both of identity provider 110 and relying party 120. Accordingly, implementations of the present invention provide one or more automated mechanisms for ensuring that security configuration updates can occur relatively seamlessly and automatically, thus immunizing either party (or even client 130) from the hassle sometimes associated with such changes.

As shown in FIG. 1C, for example, identity provider 120 has updated its policies 105 (i.e., to policies 105a). Such changes could be a simple as renaming configuration documents, or changing endpoints for documents. Such changes could also be as complex as substantive changes to accepted communication protocols, digital certificates and/or keys used for signatures, or the like. In many cases, changes in security policies will necessitate a change in the published security information.

Accordingly, FIG. 1C shows that determination module 115 updates the published security configuration document 117 (i.e., to document 117a). In one implementation, this publication of the new security document 117a comprises simply overwriting or removing the metadata in prior security configuration document 117. In at least one implementation, however, identity provider 110 publishes the new security configuration document 117a metadata at the same time as it publishes the security configuration metadata in document 117, and then phases out the prior security configuration document 117 over some time interval. In at least one implementation, such gradual phasing out of the published security configurations 117/117a can help ensure continuity of service with the one or more relying parties 120.

In any case, identity provider 110 and relying party 120 will ultimately need to go through similar iterations of the discovery, decision, and confirmation phases described with respect to FIG. 1A. For example, FIG. 1C shows that identity provider 110 and relying party 120 undergo discovery phase 185, decision phase 190 and confirmation 195, each pertaining to the updated security configuration document 117a. For example, when identity provider 110 publishes the updated security configuration document 117a, relying party 120 will ultimately need to identify and review the updated information in order to maintain or continue with the established trust relationship. Thus, identity provider 110 might send one or more messages (which may include the updated security configuration document 117a) to relying party 120 indicating the change in configurations.

In additional or alternative implementations, relying party 120 (and/or identity provider 110 in the alternate case) may be configured to periodically check for changes in security information at identity provider 110 (and vice versa), such as once every few minutes, days, or weeks, etc. In one implementation, relying party 120 is configured to check for updates in accordance with an interval previously prescribed by identity provider 110 when setting up the trust relationship initially. For example, one of the security configurations in document 117 could indicate that identity provider 110 promises to update security configurations once a week, and that it will maintain an old security configuration document no more than one-two days after an update. Relying party 120 can thus configure one or more components to send a request to identity provider 110 for any updates of the security configurations once every other day, or every three days, as appropriate.

Similarly, identity provider 110 can be configured to send one or more generic messages to all relying parties (with which it has an established trust relationship), which asks each relying party 120 to perform an update of security configuration information. In still further or alternative implementations, identity provider 110 could be prompted to send updated security documents 117a to relying party upon receiving an indication (e.g., from client 130) that relying party 120 failed to validate a particular token. Such an exchange by identity provider 110 could further include one or more requests to identify if the validation failure was based on old security configurations from document 117, or that relying party 120 has updated its security configurations.

In any event, FIG. 1C shows that relying party 110 communicates with identity provider 110 as part of the discovery phase 185, such by sending a security document (e.g., 117a), or sending an indication of its presence. Relying party 120 in turn, receives the updated security configuration information in document 117a. In some cases relying party 120 may even send an updated security configuration document (not shown) to identity provider 110 as part of discovery phase 185. Relying party 120 (and in some cases identity provider 110) then enters decision phase 190, in which relying party 120 compares the information in updated document 117a through determination module 125 with its current policies 123. As previously mentioned, decision phase 190 could involve any number of additional workflow processes at relying party 120 and/or identity provider 110.

If the new security configurations in document 117a present no problems for relying party (and vice versa with identity provider 110, as appropriate) relying party 120 and identity provider 110 can maintain their current trust relationship, albeit with different security configuration information. As shown in FIG. 1C, relying party 120 and identity provider 110 thus confirm the updated settings via confirmation phase 195. Of course, as before, if the change to the security configurations (in document 117a) means that the there is no overlap in current security configurations, either party could then terminate the trust relationship in confirmation phase 195.

Thus, as a result, when client 130 again requests services for relying party 120, FIG. 1C shows that client 130 sends a new message 165a through channel 143, which requests services of relying party 120. Relying party 120, in turn, sends one or more response messages 170a back to client 130, via channel 143, which requests a valid security token to use the requested services. As shown previously in FIG. 1B, client 130 then sends one or more messages 175a to identity provider 110 over channel 137, which asks for the security token requested by relying party 120. In this particular case however, identity provider 110, rather than regenerating the previous security token that it sent, now generates an updated security token, and sends the updated security token via one or more messages 180a. For example, FIG. 1C shows that identity provider 110 sends one or more updated security tokens via one or more messages 180a, which conform to relying party policies 123 and the updated identity provider policies 105a. Client 130 can then pass this updated security token in the one or more messages 180a to relying party 120, which then validates this security token.

Since, in this case, relying party 120 previously received and successfully processed security configuration document 117a, relying party 120 can then validate the new security token received from client 130. Accordingly, client 130 can continue to access the requested services of relying party 120, even though there has been a change in security information. More specifically, this means that the client 130 can continue to have a seamless experience accessing various services while the corresponding identity providers 110 and relying parties 120 automatically and seamlessly process hundreds and thousands of security configuration changes, potentially with hundreds and thousands of other parties in a trust relationship. Similarly, this means that identity providers and relying parties can also have a seamless experience in that they can establish trust relationships and maintain and/or end these relationships with hundreds or even thousands of opposing parties in trust relationships automatically, and with a great deal of efficiency and ease.

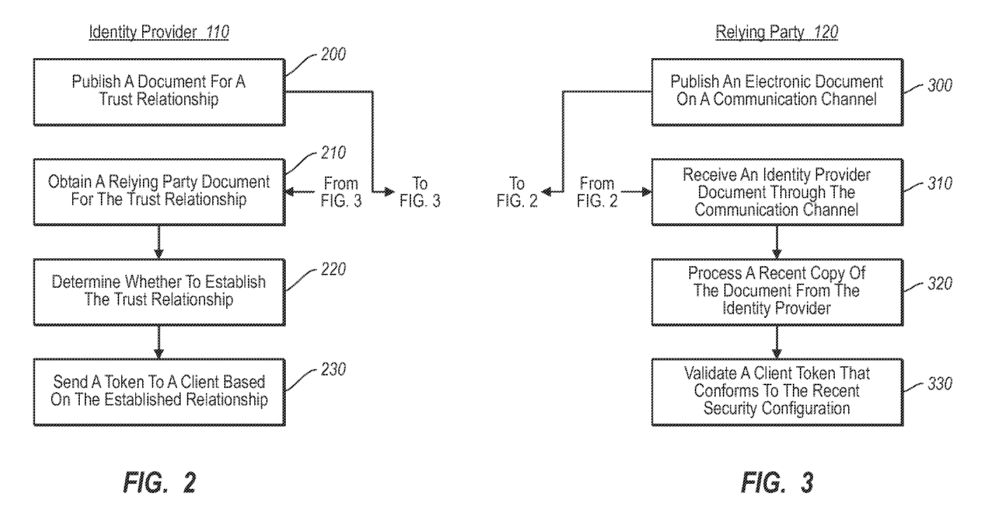

In addition to the foregoing, implementations of the present invention can also be described in terms of flow charts comprising one or more acts in a method for accomplishing a particular result. For example, FIG. 2 illustrates a method from the perspective of an identity provider 110 for establishing a trust relationship with a relying party. Similarly, FIG. 3 illustrates a method from the perspective of a relying party 120 for establishing a trust relationship with an identity provider, and for validating tokens provided by the identity provider. Of course, one will appreciate that since many of the mechanisms described herein for establishing the trust relationship are essentially reciprocal, one will appreciate that the method acts from the perspective of the identity provider 110 or relying party 120 (below) can be switched with respect to the other provider, and are thus equally applicable to the other provider's perspective. In any event, the methods of FIGS. 2 and 3 are discussed more fully below with respect to the components and diagrams of FIGS. 1A through 1C.

For example, FIG. 2 shows that a method from the perspective of identity provider 110 (or, alternatively relying party 120) can comprise an act 200 of publishing a document for a trust relationship. Act 200 includes publishing a document pertaining to a trust relationship, wherein the published document defines security configuration data for the identity provider. For example, FIG. 1A shows that identity provider 110 publishes security configuration document 117.

FIG. 2 also shows that the method from the perspective identity provider 110 can comprise an act 220 of obtaining a relying party document for the trust relationship. Act 220 includes receiving one or more documents through a first communication channel from a relying party pertaining to the trust relationship, wherein the received document defines security configuration data for the relying party. For example, FIG. 1A shows that identity provider 110 and relying party 120 can perform a discovery phase 140, wherein identity provider 110 identifies security configuration information 127 that has been published by relying party 120.

In addition, FIG. 2 shows that the method from the perspective of identity provider 110 can comprise an act 220 of determining whether to establish the trust relationship. Act 220 includes processing the document received from the relying party to determine whether to establish the trust relationship. For example, as shown in FIG. 1A, identity provider 110 and relying party 120 enter into a decision phase 150. In this case, identity provider's 110 information module 120 will determine whether the security configuration information published in document 127 conforms to the security configuration information found in document 117 published by identity provider.

Furthermore, FIG. 2 shows that the method from the perspective of identity provider 110 can comprise an act 230 of sending a token based on the established relationship. Act 230 includes, upon establishing the trust relationship, sending one or more security tokens to be validated by the relying party, wherein the one or more security tokens conform to security configurations received from the relying party via the first communication channel. For example, as shown in FIG. 1B, identity provider 110 sends one or more tokens 180 to relying party 120 (via client 130). The token sent to relying party 120, in turn, conforms to the security configuration metadata previously exchanged through communication channel 133, as shown in FIG. 1A.

In addition to the foregoing, FIG. 3 illustrates that an additional or alternative method from the perspective of relying party 120 (or, alternative identity provider 110) for establishing, monitoring and maintaining a trust relationship can comprise an act 300 of publishing an electronic document on a communication channel. Act 300 includes publishing an electronic document pertaining to a trust relationship on a first communication channel, wherein the published electronic document contains security configuration data for the relying party. For example, as shown in FIG. 1A, relying party publishes document 127, which comprises security configuration metadata used by relying party 120.

FIG. 3 also shows that the method from the perspective of relying party 120 can comprise an act 310 of receiving an identity provider document through the communication channel. Act 310 includes receiving one or more electronic documents through the first communication channel from an identity provider pertaining to the trust relationship, wherein the received one or more electronic documents define security configuration data for the identity provider. For example, FIG. 1A shows that identity provider 110 and relying party 120 enter into a discovery phase 140, whereby relying party 120 identifies and/or receives security configuration metadata in a document 117 published by identity provider 110.

In addition, FIG. 3 shows that a method from the perspective of relying party 120 can comprise an act 320 of processing a recent copy of the document from the identity provider 110. Act 320 includes processing a most recent copy of the received document from the identity provider to determine whether to maintain the trust relationship. For example, as shown in FIG. 1A, relying party 120 processes configuration document 117, and stores a representation of the identity provider policies 105 with its own set of policies 123. Similarly, as shown in FIG. 1C, relying party 120 processes configuration document 117a (the most recent version of the security configuration settings), and stores a representation of the identity provider policies 105a with its own set of policies 123.

Furthermore, FIG. 3 shows that the method from the perspective of relying 120 can comprise an act 330 of validating a client token that conforms to the recent security configurations. Act 330 includes validating one or more security tokens received from a client through a second communication channel, wherein the received one or more security tokens conform to the most recent security configuration data received from the identity provider via the first communication channel. For example, as shown in FIGS. 1B and 1C, upon receiving one or more requests 165 or 165a for services, relying party 120 sends one or more requests 170 or 170a back to the client 130 for a particular token. Upon receiving client requests 175 or 175a, identity provider 110 sends to client 130 (or directly to relying party 120 in some cases) the requested token via one or more messages 180 or 180a. Relying party 120 can then determine whether the received token conforms to the policies that have been outlined in the presently established trust relationship with identity provider 110.

Accordingly, implementations of the present invention provide convenient and efficient ways or mechanisms for establishing, maintaining, and monitoring a trust relationship. As previously described this can be accomplished at least in part by publishing and retrieving trust information that can be discovered by an interested party. The interested party(ies) can then use the information (even processing the information automatically) to inform and update local policy representing the trust relationship. Furthermore, the interested parties can use essentially the same automated protocols for establishing the trust relationship to automatically notify or poll partners for updates to the trust relationship, and thus keep the trust information synchronized.

The embodiments of the present invention may comprise a special purpose or general-purpose computer including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At an identity provider in computerized environment comprising a federated system having the identity provider, one or more relying parties, and one or more clients, a method of securely and automatically establishing, monitoring, and maintaining a trust relationship pursuant to verifying security tokens for client access to services, comprising the acts of:
publishing a document pertaining to a trust relationship, wherein the published document defines security configuration data for the identity provider;
receiving one or more documents through a first communication channel from a relying party pertaining to the trust relationship, wherein the received document defines security configuration data for the relying party;
processing the document received from the relying party to determine whether to establish the trust relationship; and
upon establishing the trust relationship, sending one or more security tokens to be validated by the relying party, wherein the one or more security tokens conform to security configurations received from the relying party via the first communication channel.

2. The method as recited in claim 1, wherein the one or more documents received through the first communication channel relate to establishing a trust relationship in the first instance.

3. The method as recited in claim 1, wherein the one or more documents received through the first communication channel relate to maintaining or monitoring an existing trust relationship that has already been established between the identity provider and the relying party.

4. The method as recited in claim 1, wherein the act of sending one or more security tokens further comprises sending the one or more security tokens directly to a client that accesses services at the relying party through at least a second communication channel.

5. The method as recited in claim 1, wherein the act of sending one or more security tokens further comprises sending the one or more security tokens directly to the relying party through the first communication channel on behalf of a client.

6. The method as recited in claim 1, further comprising an act of receiving a request from a client for a token to access services at the relying party.

7. The method as recited in claim 6, further comprising the acts of:
identifying that there is no existing trust relationship with the relying party; and
sending one or more queries to the relying party to identify any security configuration documents.

8. The method as recited in claim 7, wherein the act of publishing the document further comprises an act of including the document with the one or more queries sent to the relying party to identify any security configuration documents.

9. The method as recited in claim 1, wherein the act of processing the document from the relying party further comprises determining that the defined security configuration data in the received document is consistent with one or more security policies at the identity provider.

10. The method as recited in claim 1, further comprising an act of formatting the one or more security tokens to be validated in accordance with defined security configuration data in both the document at the identity provider and the document received from the relying party.

11. The method as recited in claim 1, further comprising the acts of:
identifying one or more security policy updates at the identity provider; and
automatically publishing a new document that defines updated security configuration data for the identity provider.

12. The method as recited in claim 11, further comprising the acts of:
receiving one or more confirmations from the relying party that the updated security configuration data is accepted; and
automatically formatting the one or more security tokens to be validated in accordance with security policy updates at the identity provider and the security configuration data in the document received from the relying party.

13. The method as recited in claim 11, further comprising the acts of:
receiving one or more confirmations from the relying party that the updated security configuration data is not accepted; and
sending one or more confirmation message to the relying party to end the trust relationship.

14. At a relying party in computerized environment comprising a federated system having the relying party, one or more identity providers, and one or more clients, a method of securely and automatically establishing, monitoring, and maintaining a trust relationship through a communication channel that is independent of a client, pursuant to validating tokens received from the client, comprising the acts of:
publishing an electronic document pertaining to a trust relationship on a first communication channel, wherein the published electronic document defines security configuration data for the relying party;
receiving one or more electronic documents through the first communication channel from an identity provider pertaining to the trust relationship, wherein the received one or more electronic documents define security configuration data for the identity provider;
processing a most recent copy of the received document from the identity provider to determine whether to maintain the trust relationship; and
validating one or more security tokens received from a client through a second communication channel, wherein the received one or more security tokens conform to the most recent security configuration data received from the identity provider via the first communication channel.

15. The method as recited in claim 14, further comprising the acts of:
receiving one or more requests from the client for access to one or more services at the relying party; and
determining that the client needs to present one or more tokens to access the requested one or more services.

16. The method as recited in claim 15, further comprising an act of receiving one or more indications from the client that the one or more tokens can be obtained through the identity provider.

17. The method as recited in claim 16, further comprising an act of the relying party sending one or more queries through the first communication channel to the identity provider to establish the trust relationship, wherein the one or more queries include a copy of the published electronic document.

18. The method as recited in claim 14, further comprising the acts of:
identifying an update to one or more security policies at the relying party; and
automatically publishing an update to the published electronic document, wherein the update to the published electronic document defines updated security configuration data for the relying party.

19. The method as recited in claim 14, further comprising the acts of:
identifying that one or more tokens received from the identity provider fail to conform to the updated security policies; and
sending one or more messages to the identity provider that contain the update to the published electronic document.

20. At an identity provider in computerized environment comprising a federated system having the identity provider, one or more relying parties, and one or more clients, a computer program storage product having computer-executable instructions stored thereon that, when executed, cause one or more processors at the identity provider to perform a method comprising:
publishing a document pertaining to a trust relationship, wherein the published document defines security configuration data for the identity provider;
receiving one or more documents through a first communication channel from a relying party pertaining to the trust relationship, wherein the received document defines security configuration data for the relying party;
processing the document received from the relying party to determine whether to establish the trust relationship; and
upon establishing the trust relationship, sending one or more security tokens to be validated by the relying party, wherein the one or more security tokens conform to security configurations received from the relying party via the first communication channel.
